(19) United States
(12) Patent Application Publication
(10) Pub. No.: US 2025/0224270 A1
(43) Pub. Date: Jul. 10, 2025

(54) BOUNDARY FLAPS CONTAING PIEZOELECTRIC SENSORS AND SYSTEMS USING THE SAME

(71) Applicant: IPEG, INC., Cranberry Township, PA (US)

(72) Inventors: Evan Edward Prem, Allison Park, PA (US); Alex Thomas Rayburg, Lower Burrell, PA (US); Joseph Francis Maciolek, Glastonbury, CT (US); Justin Louis Weber, Pennsburg, PA (US); Max Jeffrey Rayburg, Lower Burrell, PA (US); Dean Veiga Wedley, Yardley, PA (US); Vinh-Duy Thai Nguyen, Cranberry Township, PA (US); Eric Jason Rathbun, Gibsonia, PA (US); Matthew William Shope, Beaver Falls, PA (US)

(21) Appl. No.: 19/013,739

(22) Filed: Jan. 8, 2025

Related U.S. Application Data
(60) Provisional application No. 63/618,622, filed on Jan. 8, 2024.

(51) Int. Cl. G01H 11/08; B01J 4/00; G05B 13/02

(52) U.S. Cl. CPC G01H 11/08; B01J 4/001; G05B 13/0255

(57) ABSTRACT

A boundary flap for defining boundaries of entryways or other locations on, within or associated with a machine or equipment, comprising a flap and a piezoelectric sensor disposed in or on the flap.

### RELATED APPLICATION

This application claims priority benefit under 35 U.S.C. § 119(e) of U.S. Provisional Application No. 63/618,622 filed Jan. 8, 2024, the contents of which are herein incorporated by reference.

### FIELD OF THE DISCLOSURE

This present disclosure is related to sensors for detecting entry of an object or objects into an area, volume or machine. More specifically, the present disclosure is related to piezoelectric sensors disposed in boundary flaps disposed in an entryway for detecting entry of an object or objects into an area through such entryway.

### BACKGROUND

Traditionally, boundary flaps are used to cover the material entrance into size reduction equipment. This prevents material from exiting while it is being granulated. Every time materials or objects are inserted into the machine, they must pass through these boundary flaps.

Such boundary flaps, however, do not incorporate reliable sensors for detecting entry of materials or objects into processing equipment or machines. Thus, it is desired to provide boundary flaps containing reliable sensors for detecting entry of an object or objects into an area or machine through an entryway in which such boundary flaps are disposed.

### BRIEF SUMMARY OF THE DISCLOSURE

In a preferred aspect, the present disclosure comprises a boundary flap for defining boundaries of entryways or other locations on, within or associated with a machine or equipment, comprising a flap and a piezoelectric sensor disposed in or on the flap.

In another preferred aspect of a boundary flap of the present disclosure, the piezoelectric sensor comprises a piezoelectric coaxial cable sensor or a piezoelectric film sensor.

In yet another preferred aspect of a boundary flap of the present disclosure, the flap comprises a first flap member and a second flap member; wherein the piezoelectric sensor comprises a piezoelectric coaxial cable sensor disposed between the first and second flap members; and wherein the first and second flap members are attached together.

In another preferred aspect of a boundary flap of the present disclosure, the flap comprises a first flap member and a second flap member; wherein the piezoelectric sensor comprises a piezoelectric film sensor disposed between the first and second flap members; and wherein the first and second flap members are attached together.

In a further preferred aspect of a boundary flap of the present disclosure, the flap is made from polyurethane.

In another preferred aspect of a boundary flap of the present disclosure, the first and second flap members are made from polyurethane.

In another preferred aspect, the present disclosure comprises a material processing or handling machine having an entryway or other location on, within or associated with the machine, comprising one or more boundary flaps for designating one or more boundaries associated with the entryway or other location on, within or associated with the machine; and one or more piezoelectric sensors disposed in or on the one or more boundary flaps.

In another preferred aspect of a material processing or handling machine of the present disclosure, each of the one or more piezoelectric sensors comprises a piezoelectric coaxial cable sensor or a piezoelectric film sensor.

In yet another preferred aspect of a material processing or handling machine of the present disclosure, each of the one or more boundary flaps comprises a first flap member and a second flap member; wherein the piezoelectric sensor comprises a piezoelectric coaxial cable sensor disposed between the first and second flap members; and wherein the first and second flap members are attached together.

In another preferred aspect of a material processing or handling machine of the present disclosure, the one or more boundary flaps are made from polyurethane.

In yet another preferred aspect, the present disclosure comprises a material processing or handling machine having an entryway or other location on, within or associated with the machine, comprising one or more boundary flaps for designating one or more boundaries associated with the entryway or other location on, within or associated with the machine; one or more piezoelectric sensors disposed in or on the one or more boundary flaps; and a computer or other processor in wired or wireless communication with the one or more piezoelectric sensors disposed in or on the one or more boundary flaps.

In another preferred aspect of a material processing or handling machine of the present disclosure, each of the one or more piezoelectric sensors comprises a piezoelectric coaxial cable sensor or a piezoelectric film sensor.

In a further preferred aspect of a material processing or handling machine of the present disclosure, each of the one or more boundary flaps comprises a first flap member and a second flap member; wherein the piezoelectric sensor comprises a piezoelectric coaxial cable sensor disposed between the first and second flap members; and wherein the first and second flap members are attached together.

In another preferred aspect of a material processing or handling machine of the present disclosure, each of the one or more boundary flaps comprises a first flap member and a second flap member; wherein the piezoelectric sensor comprises a piezoelectric film sensor disposed between the first and second flap members; and wherein the first and second flap members are attached together.

In yet another preferred aspect of a material processing or handling machine of the present disclosure, the one or more boundary flaps are made from polyurethane.

In another preferred aspect of a material processing or handling machine of the present disclosure, the computer or other processor in wired or wireless communication with the one or more piezoelectric sensors disposed in or on the one or more boundary flaps can: (1) detect a presence and/or a movement of materials within the entryway or other location on, within or associated with the machine; (2) automatically turn on the machine by sensing material entry into the entryway; (3) automatically turn off the machine by sensing no material entering such machine for a predetermined period of time; (4) log historically when material was inserted into the machine; and/or (5) predict when material will be inserted into machine using historical detection data generated by the machine and stored in a memory in wired or wireless communication with the machine.

In a further preferred aspect of a material processing or handling machine of the present disclosure, the one or more boundary flaps are made from polyurethane.

In another preferred aspect of a material processing or handling machine of the present disclosure, the one or more piezoelectric sensors disposed in or on the one or more boundary flaps are calibrated to minimize false-positives and false-negatives with respect to movements of the one or more boundary flaps from causes other than material existing or moving at the one or more boundaries associated with the entryway or other location on, within or associated with the machine.

### BRIEF DESCRIPTION OF THE DRAWINGS

For the present disclosure to be easily understood and readily practiced, the present disclosure will now be described for purposes of illustration and not limitation in connection with the following figures, wherein:

FIG. 1 is a top perspective view of a plastics material processing or handling machine, such as a granulator, of the present disclosure incorporating boundary flaps containing piezoelectric sensor;

FIG. 2 is a top perspective view of a piezoelectric film sensor disposed on boundary flaps according to a preferred embodiment of the present disclosure;

FIG. 3 is a top perspective view of piezoelectric film sensors and flexible resistive sensors disposed on boundary flaps according to another preferred embodiment of the present disclosure;

FIG. 4 is a top perspective view of material processing or handling machine having an entryway comprising boundary flaps designating a boundary associated with the entryway and piezoelectric sensors disposed in or on the boundary flaps according to another preferred embodiment of the present disclosure;

FIG. 5 is a top perspective view of another preferred embodiment of a material processing or handling machine having an entryway comprising boundary flaps designating a boundary associated with the entryway and piezoelectric sensors disposed in or on the boundary flaps according to the present disclosure;

FIG. 6 is a top perspective view of a preferred embodiment of boundary flaps comprising embedded piezoelectric coaxial cable sensors according to the present disclosure;

FIG. 7 is a top plan view of a preferred embodiment of boundary flaps according to the present disclosure;

FIG. 8 is an exploded view of a preferred embodiment of boundary flaps comprising embedded piezoelectric coaxial cable sensors according to the present disclosure;

FIG. 9 shows top perspective views of a piezoelectric coaxial sensor and a piezoelectric film sensor plastics used in boundary flaps of the present disclosure.

### DETAILED DESCRIPTION

In the following detailed description, reference is made to the accompanying examples and figures that form a part hereof, and in which is shown, by way of illustration, specific embodiments in which the inventive subject matter may be practiced. These embodiments are described in sufficient detail to enable those skilled in the art to practice them, and it is to be understood that other embodiments may be utilized and that structural or logical changes may be made without departing from the scope of the inventive subject matter. Such embodiments of the inventive subject matter may be referred to, individually and/or collectively, herein by the term “invention” merely for convenience and without intending to voluntarily limit the scope of this application to any single disclosure or inventive concept if more than one is in fact disclosed.

The following description is, therefore, not to be taken in a limited sense, and the scope of the inventive subject matter is defined by the appended claims and their equivalents.

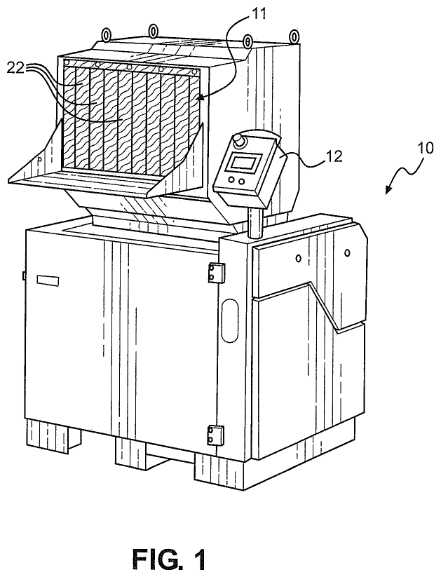

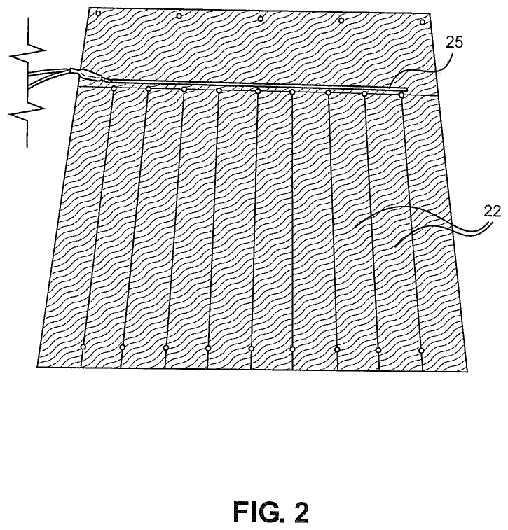

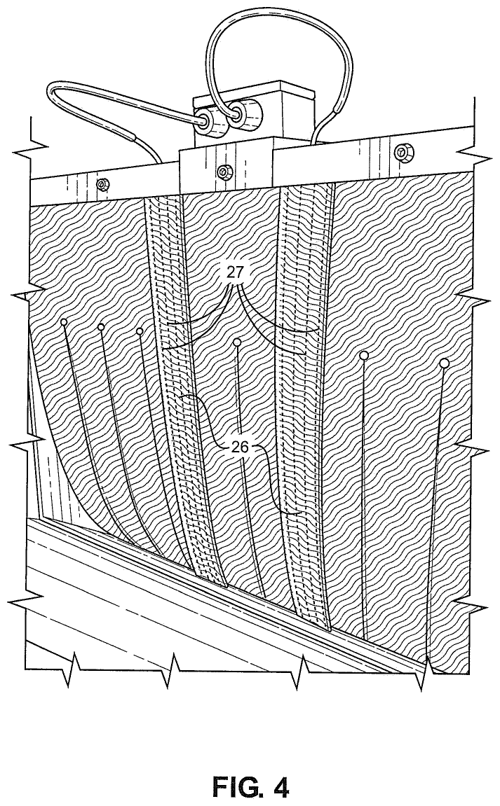

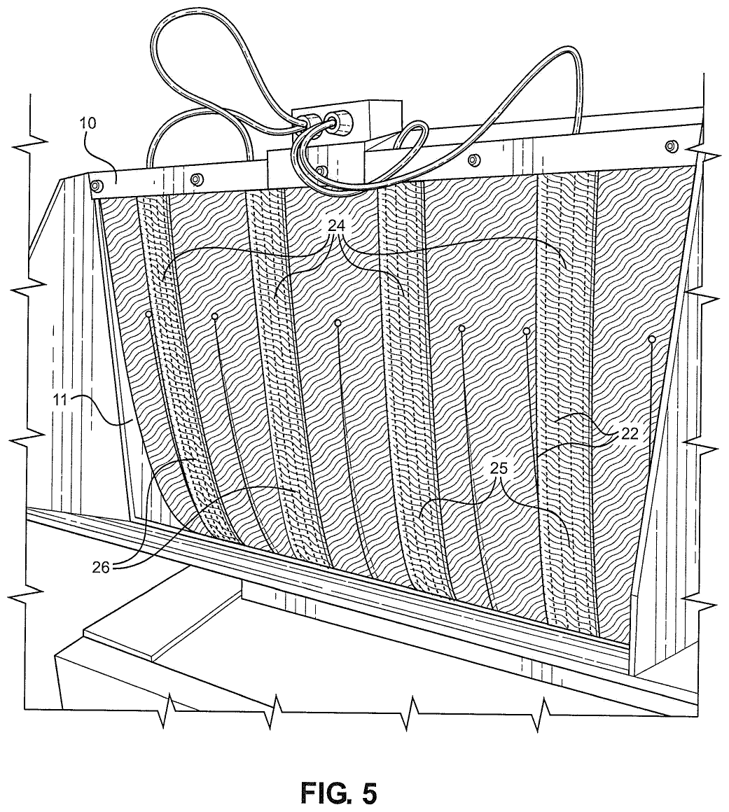

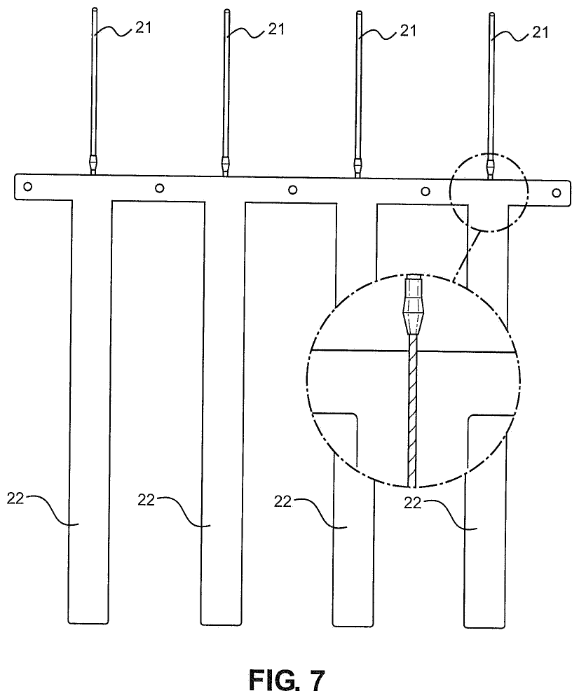

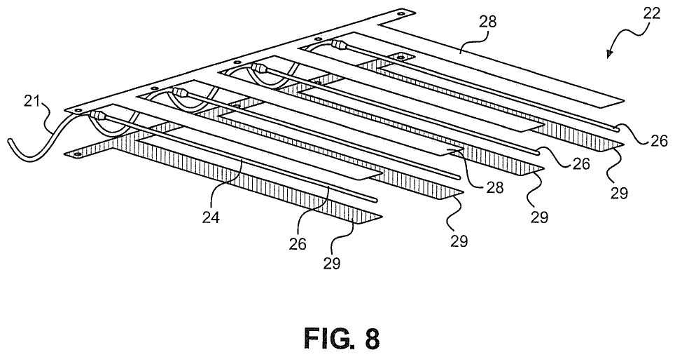

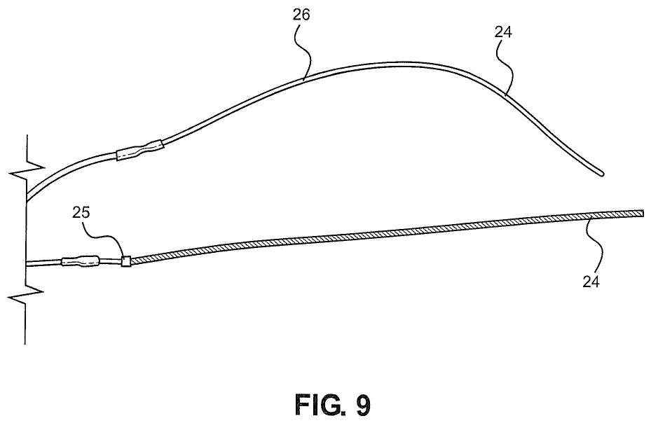

In its broadest sense, an illustrated preferred embodiment of the present disclosure comprises boundary flaps 22 containing piezoelectric sensors 24 for disposed in an opening or entryway in electronic communication with a processor for detecting movement of an object moving through the opening or entryway is shown in FIGS. 1-9.

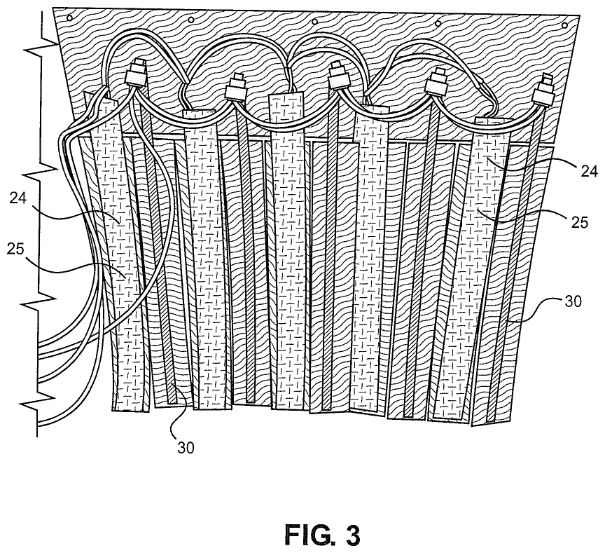

Another illustrated preferred embodiment of the present disclosure comprises a plastics material processing or handling machine 10, such as a granulator, incorporating boundary flaps 22 containing piezoelectric sensors 24 in electronic communication with processor 12 for covering the material opening entryway 11 of machine 10 is shown in FIGS. 1-5. Boundary flaps 22 containing piezoelectric sensors 24 are used for detecting movement of material to be processed through opening 11. When piezoelectric sensors 24 are bent or stretched, a voltage is generated and received by processor 12 via leads or wires 21 or wirelessly via Bluetooth or other wireless network. Preferably, piezoelectric sensors 24 may comprise piezoelectric film sensors 25 or piezoelectric coaxial cable sensors 26. In a most preferred embodiment shown in FIGS. 3-4 and 6-8, each boundary flap 22 comprises a piezoelectric coaxial cable sensor 26 disposed between first flap member 28 and second flap member 29 which are stitched together with stitching 27 and/or bonded together using an adhesive, such as a cyanoacrylate-based adhesive. Alternatively, as shown in FIG. 3, sensors 28 in boundary flaps 22.

When material is shoved through opening 11 causing boundary flaps 22 to flex or bend, processor 12 can detect this movement as the voltage generated by piezoelectric sensors 24 in boundary flaps 22. Using this signal, processor 12 of machine 10 monitors when material enters machine 10 via opening 11 and allows to perform the following actions: (1) automatically turn on the machine 10 by detecting when material enters the machine 10 via opening 11; (2) using the vibration of machine 10 in operation and piezoelectric flap sensors 24 to automatically turn off machine 10 after it finishes processing the material and no new material has entered machine 10; (3) log when material was inserted into machine 10 to provide historical trending of material entry; (4) predict when material will be inserted into machine 10 using historical detection timestamps from sensors 24; and (5) calibrate the piezoelectric sensors 24 to prevent false-positives and/or false-negatives with respect to movements of boundary flaps 22 from causes other than material entering or exiting opening 11 of machine 10. Preferably, vibration of machine 10 is sensed using an accelerometer disposed on machine 10 to know when to automatically turn off the machine and to calibrate the piezoelectric and/or non-piezoelectric sensors to prevent false-positives and/or false-negatives with respect to movements of boundary flaps 22 from causes other than material entering or exiting opening 11 of machine 10.

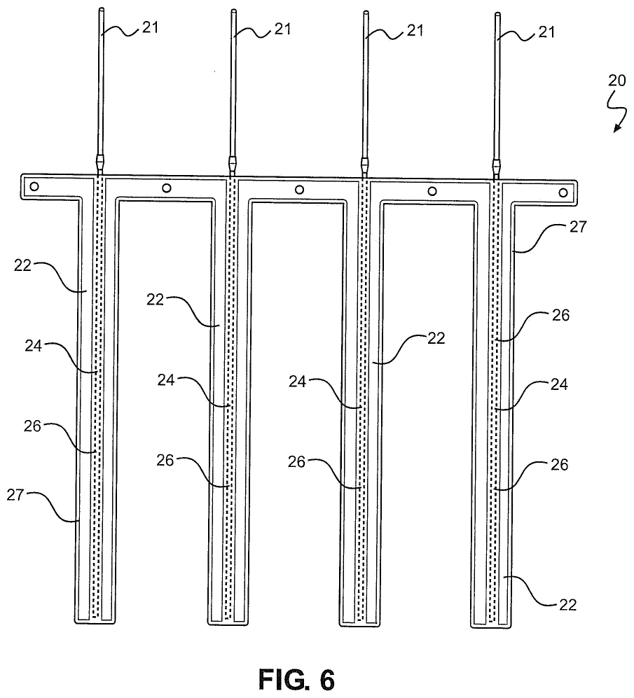

As shown in FIGS. 6-8, a preferred embodiment of boundary flaps 22 for use in machine 10, such as a plastics granulator, uses four piezoelectric coaxial sensors 26 wired in parallel with a 1 megaohm (MΩ) resistor. Preferably, an analog measuring device is used to interpret the signal from the four piezoelectric coaxial sensors 26 wired in parallel. Alternatively, flat film piezoelectric sensors 25 and/or flexible resistive sensors (FRSs) 30 may be used in boundary flaps 22 as shown in FIG. 3.

System 20 comprising boundary flaps 22 containing piezoelectric sensors 24 according to the present disclosure preferably may be used: (1) on industrial equipment to detect the presence and/or movement of materials, such as raw materials for plastics manufacturing or processing; (2) on auxiliary equipment to detect the presence and/or movement of materials, such as raw materials for plastics manufacturing or processing; (3) on size reduction equipment to detect the presence and/or movement of materials, such as raw materials for plastics manufacturing or processing; (4) to automatically turn on equipment, such as size reduction equipment, by sensing material entry; (5) to automatically turn off equipment, such as size reduction equipment, by sensing no material entering such equipment for an extended or predetermined period of time; (6) to log historically when material was inserted into equipment, such as size reduction equipment; and (7) to predict when material will be inserted into equipment, such as size reduction equipment, using historical detection data. Preferably, piezoelectric sensors 24 of boundary flaps 22 are calibrated to minimize or prevent false-positive and negative reading when detecting material entry or presence in equipment such as size reduction equipment.

In the foregoing Detailed Description, various features are grouped together in a single embodiment to streamline the disclosure. This method of disclosure is not to be interpreted as reflecting an intention that the claimed embodiments of the disclosure require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A boundary flap for defining boundaries of entryways or other locations on, within or associated with a machine or equipment, comprising:
a flap and a piezoelectric sensor disposed in or on the flap.

2. The boundary flap of claim 1 wherein, the piezoelectric sensor comprises a piezoelectric coaxial cable sensor or a piezoelectric film sensor.

3. The boundary flap of claim 1 wherein, the flap comprises a first flap member and a second flap member; wherein the piezoelectric sensor comprises a piezoelectric coaxial cable sensor disposed between the first and second flap members; and wherein the first and second flap members are attached together.

4. The boundary flap of claim 1 wherein, the flap comprises a first flap member and a second flap member; wherein the piezoelectric sensor comprises a piezoelectric film sensor disposed between the first and second flap members; and wherein the first and second flap members are attached together.

5. The boundary flap of claim 1 wherein, the flap is made from polyurethane.

6. The boundary flap of claim 3 wherein, the first and second flap members are made from polyurethane.

7. A material processing or handling machine having an entryway or other location on, within or associated with the machine, comprising:
one or more boundary flaps for designating one or more boundaries associated with the entryway or other location on, within or associated with the machine; and
one or more piezoelectric sensors disposed in or on the one or more boundary flaps.

8. The material processing or handling machine of claim 7 wherein, each of the one or more piezoelectric sensors comprises a piezoelectric coaxial cable sensor or a piezoelectric film sensor.

9. The material processing or handling machine of claim 7 wherein, each of the one or more boundary flaps comprises a first flap member and a second flap member; wherein the piezoelectric sensor comprises a piezoelectric coaxial cable sensor disposed between the first and second flap members; and wherein the first and second flap members are attached together.

10. The material processing or handling machine of claim 7 wherein, the one or more boundary flaps are made from polyurethane.

11. A material processing or handling machine having an entryway or other location on, within or associated with the machine, comprising:
one or more boundary flaps for designating one or more boundaries associated with the entryway or other location on, within or associated with the machine;
one or more piezoelectric sensors disposed in or on the one or more boundary flaps; and
a computer or other processor in wired or wireless communication with the one or more piezoelectric sensors disposed in or on the one or more boundary flaps.

12. The material processing or handling machine of claim 11 wherein, each of the one or more piezoelectric sensors comprises a piezoelectric coaxial cable sensor or a piezoelectric film sensor.

13. The material processing or handling machine of claim 11 wherein, each of the one or more boundary flaps comprises a first flap member and a second flap member; wherein the piezoelectric sensor comprises a piezoelectric coaxial cable sensor disposed between the first and second flap members; and wherein the first and second flap members are attached together.

14. The material processing or handling machine of claim 11 wherein, each of the one or more boundary flaps comprises a first flap member and a second flap member; wherein the piezoelectric sensor comprises a piezoelectric film sensor disposed between the first and second flap members; and wherein the first and second flap members are attached together.

15. The material processing or handling machine of claim 11 wherein, the one or more boundary flaps are made from polyurethane.

16. The material processing or handling machine of claim 13 wherein, the one or more boundary flaps are made from polyurethane.

17. The material processing or handling machine of claim 14 wherein, the one or more boundary flaps are made from polyurethane.

18. The material processing or handling machine of claim 11 wherein, the computer or other processor in wired or wireless communication with the one or more piezoelectric sensors disposed in or on the one or more boundary flaps can: (1) detect a presence and/or a movement of materials within the entryway or other location on, within or associated with the machine; (2) automatically turn on the machine by sensing material entry into the entryway; (3) automatically turn off the machine by sensing no material entering such machine for a predetermined period of time; (4) log historically when material was inserted into the machine; and/or (5) predict when material will be inserted into machine using historical detection data generated by the machine and stored in a memory in wired or wireless communication with the machine.

19. The material processing or handling machine of claim 18 wherein, the one or more boundary flaps are made from polyurethane.

20. The material processing or handling machine of claim 11 wherein, the one or more piezoelectric sensors disposed in or on the one or more boundary flaps are calibrated to minimize false-positives and false-negatives with respect to movements of the one or more boundary flaps from causes other than material existing or moving at the one or more boundaries associated with the entryway or other location on, within or associated with the machine.
